(19) United States
(12) Patent Application Publication
(10) Pub. No.: US 2025/0333203 A1
(43) Pub. Date: Oct. 30, 2025

(54) TRAY FOR FOOD PRODUCTS

(71) Applicant: Graphic Packaging International, LLC, Atlanta, GA (US)

(72) Inventor: Jeffrey D. Smith, Solon, OH (US)

(21) Appl. No.: 19/191,170

(22) Filed: Apr. 28, 2025

Related U.S. Application Data
(60) Provisional application No. 63/639,766, filed on Apr. 29, 2024.

(51) Int. Cl. B65D 5/00; B31B 50/26; B31B 100/00; B31B 110/35; B31B 120/00; B31B 120/40; B31B 120/50; B65D 5/20; B65D 5/42; B65D 5/44; B65D 85/34

(52) U.S. Cl. CPC B65D 5/003; B31B 50/262; B65D 5/20; B65D 5/4204; B65D 5/4266; B65D 5/4295; B65D 5/443; B31B 2100/0024; B31B 2110/35; B31B 2120/002; B31B 2120/40; B31B 2120/50; B65D 85/34

(57) ABSTRACT

A tray for holding at least one food product includes a plurality of panels extending at least partially around an interior of the tray, the plurality of panels including a bottom panel, a front panel, a back panel, at least one end panel, a plurality of end flaps foldably connected to a respective panel of the plurality of panels and cooperating to form a rim extending outwardly from the plurality of panels, and denesting features comprising at least one denesting tab extending from one of the front panel and the back panel and away from the at least one end panel.

### CROSS-REFERENCE TO RELATED APPLICATION

The present application claims priority to U.S. Provisional Patent Application No. 63/639,766, filed on Apr. 29, 2024.

### INCORPORATION BY REFERENCE

The disclosures of each of U.S. patent application Ser. No. 17/519,097, entitled Tray for Food Products, filed on Nov. 4, 2021, and U.S. Provisional Patent Application No. 63/639,766, filed on Apr. 29, 2024, entitled Tray for Food Products, are hereby incorporated by reference for all purposes as if set forth in their entireties.

### BACKGROUND

The present disclosure generally relates to trays for holding at least one food product.

### SUMMARY

According to one aspect, the disclosure is generally directed to a tray for holding at least one food product, the tray comprising a plurality of panels extending at least partially around an interior of the tray, the plurality of panels comprising a bottom panel, a front panel, a back panel, and at least one end panel, a plurality of end flaps foldably connected to a respective panel of the plurality of panels and cooperating to form a rim extending outwardly from the plurality of panels, and denesting features comprising at least one denesting tab extending from one of the front panel and the back panel and away from the at least one end panel.

According to another aspect, the disclosure is generally directed to a blank for forming a tray for holding at least one food product, the blank comprising a plurality of panels for extending at least partially around an interior of the tray formed from the blank, the plurality of panels comprising a bottom panel, a front panel, a back panel, and at least one end panel, a plurality of end flaps foldably connected to a respective panel of the plurality of panels and for cooperating to form a rim extending outwardly from the plurality of panels when the tray is formed from the blank, and denesting features comprising at least one denesting tab extending from one of the front panel and the back panel and for extending away from the at least one end panel when the tray is formed from the blank.

According to another aspect, the disclosure is generally directed to a method of forming a tray for holding at least one food product, the method comprising obtaining a blank, the blank comprising a plurality of panels comprising a bottom panel, a front panel, a back panel, and at least one end panel, a plurality of end flaps foldably connected to a respective panel of the plurality of panels, and denesting features comprising at least one denesting tab extending from one of the front panel and the back panel. The method further comprises positioning the plurality of panels extending at least partially around an interior of the tray, positioning the plurality of end flaps cooperating to form a rim extending outwardly from the plurality of panels, and positioning the at least one denesting tab extending away from the at least one end panel.

Those skilled in the art will appreciate the above-stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank used to form a tray according to a first exemplary embodiment of the disclosure.

FIG. 1A is an enlarged view of a portion of the blank of FIG. 1.

FIG. 1B is an enlarged view of another portion of the blank of FIG. 1.

FIG. 2 is a perspective view of a tray formed from the blank of FIG. 1 according to the first exemplary embodiment of the disclosure.

FIG. 2A is a perspective view of the tray of FIG. 2 including a food product therein and a lidding film applied thereto.

FIG. 3 is a perspective view of the tray of FIG. 2 at least partially nested in another tray with the configuration shown in FIG. 2.

FIG. 4 is another perspective view of the nested trays of FIG. 3.

Corresponding parts are designated by corresponding reference numbers throughout the drawings.

### DETAILED DESCRIPTION

Trays according to the present disclosure can accommodate articles of numerous different shapes. For the purpose of illustration and not for the purpose of limiting the scope of the disclosure, the following detailed description describes articles such as food products, e.g., fruit or vegetable items. In one embodiment, articles described herein can be fruits such as tomatoes (e.g., cherry tomatoes, etc.), berries (e.g., blueberries, raspberries, blackberries, strawberries, etc.), apples, oranges, tangerines, clementines, lemons, limes, cherries, etc. In another embodiment, articles described herein can be product packages, containers, bottles, cans, etc., that are at least partially disposed within the tray embodiments. The articles can be used for packaging food and beverage products, for example. Packaged articles can be made from materials suitable in composition for packaging the particular food or beverage item, and the materials include, but are not limited to, glass; aluminum and/or other metals; plastics such as PET, LDPE, LLDPE, HDPE, PP, PS, PVC, EVOH, and Nylon; composite materials; and the like, or any combination thereof.

The articles described herein can include different types of food or beverage products, containers thereof, and/or having different shapes, without departing from the disclosure. In this specification, the terms “lower,” “bottom,” “upper,” and “top” indicate orientations determined in relation to fully erected and upright trays. As described herein, trays can be formed from blanks by overlapping multiple panels, portions, and/or end flaps. Such panels, portions and/or end flaps may be designated herein in terms relative to one another, e.g., “first”, “second”, “third”, etc., in sequential or non-sequential reference, without departing from the disclosure.

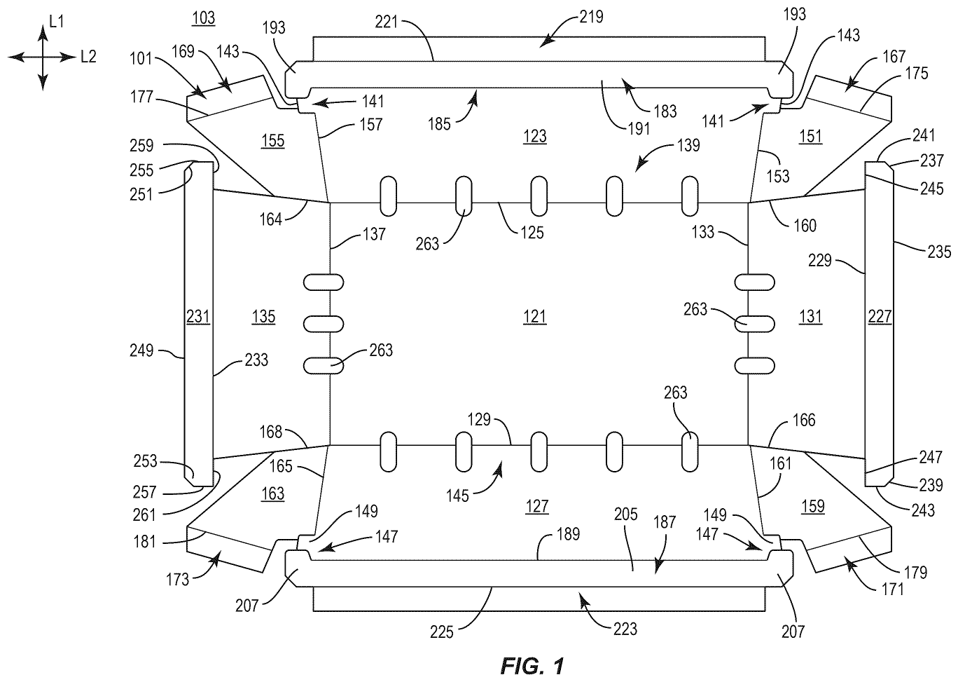

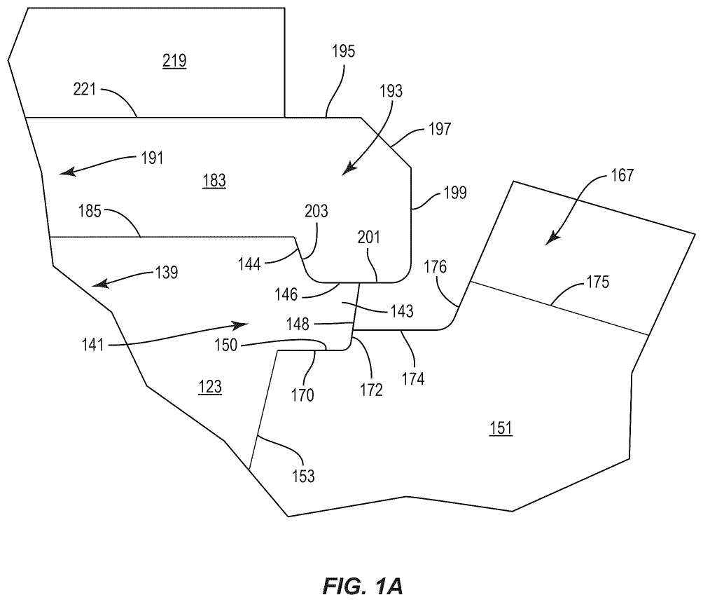

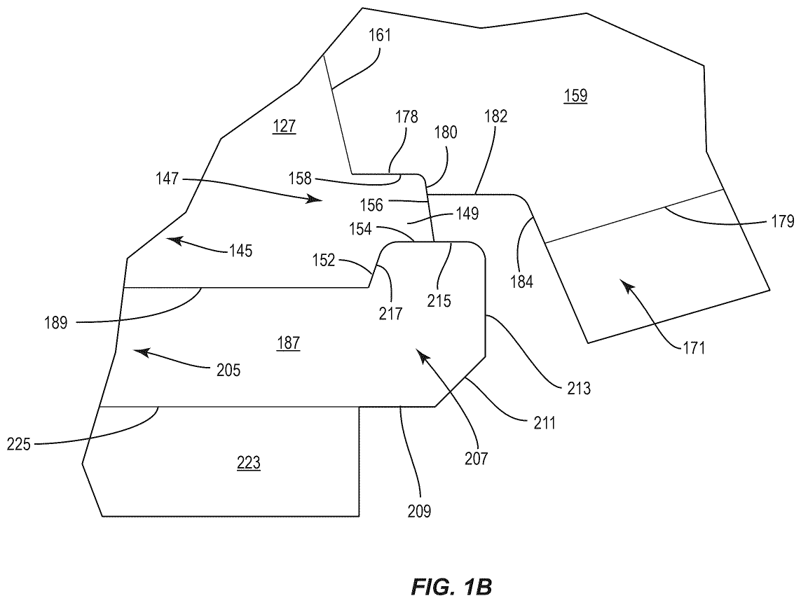

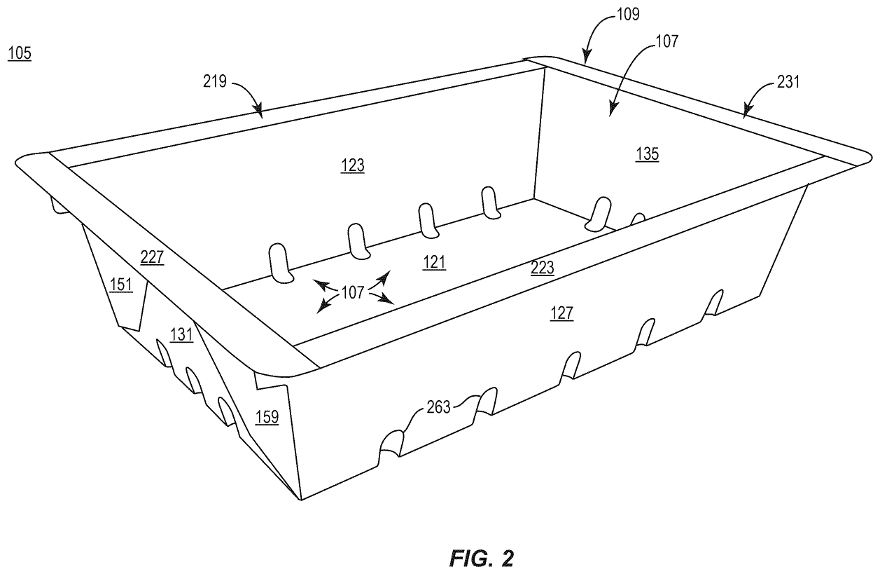

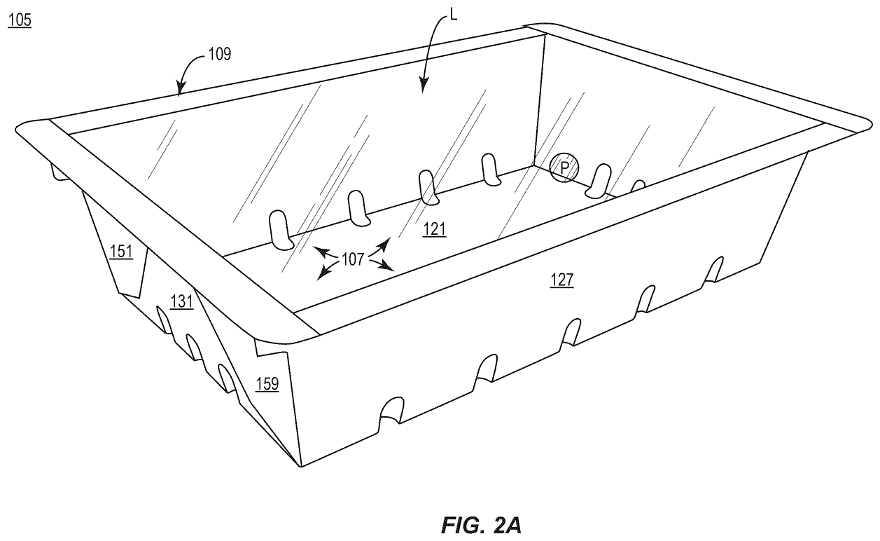

FIG. 1 is a plan view of an exterior surface 101 of a blank, generally indicated at 103, used to form a container assembly or tray 105 (FIG. 2) according to an exemplary embodiment of the disclosure. FIGS. 1A and 1B are enlarged views of portions of the blank 103. In embodiments, the trays 105 described herein can have a generally square/rectangular tapered configuration with a flanged rim. It will be understood that the trays described herein can have a different configuration without departing from the disclosure, such as a carton or other construct.

As described further herein, the blank 103 can include engagement features for forming engagement features of the tray 105 that provide one or more surfaces for engaging a machine element or other component of a system associated with the formation, loading, and/or packaging of the tray 105. In addition, the engagement features of the blank 103/tray 105 provide one or more surfaces for receiving a covering or lidding film, e.g., a polymeric film or other cover overlying the tray 105, to maintain one or more conditions of food products held therein.

The blank 103 can also include reinforcement features for forming reinforcement features of the tray 105 that reinforce, e.g., rigidize, stabilize, and/or otherwise minimize, inhibit, prevent, and/or resist deformation of the engagement features. It will be understood that, in some embodiments, one or more of the reinforcement features of the blank 103/tray 105 can be considered part of the engagement features of the tray 105, or vice versa.

The blank 103 can further include denesting or spacing/separation features to minimize, inhibit, resist, and/or avoid an undesired degree of nesting or coupling between multiple trays 105 formed from the blank 103 in a stacked arrangement, and/or can facilitate separation of such trays 105 in a stacked arrangement.

As shown, the blank 103 has a longitudinal axis L1 and a lateral axis L2 and includes a plurality of panels for extending at least partially around an interior 107 of the tray 105 when the tray 105 is formed from the blank 103. The panels can include a bottom panel 121, a side panel or front panel 123 foldably connected to the bottom panel 121 at a lateral fold line 125, a side panel or back panel 127 foldably connected to the bottom panel 121 at a lateral fold line 129, a side panel or first end panel 131 foldably connected to the bottom panel 121 at a longitudinal fold line 133, and a side panel or second end panel 135 foldably connected to the bottom panel 121 at a longitudinal fold line 137.

The front panel 123, as shown, can include a lower portion 139 foldably connected to the bottom panel 121 at the lateral fold line 125, and an upper portion 141 extending from the lower portion 139. The upper portion 141 of the front panel 123, as shown, can protrude beyond respective endpoints of a respective pair of fold lines 153, 157 associated with the front panel 123 along the lateral axis L2, as described further below, so as to intersect such fold lines 153, 157.

The upper portion 141 of the front panel 123 can thus define a pair of denesting tabs 143 (broadly, “first denesting tab” and “second denesting tab” or “third denesting tab” and “fourth denesting tab”) extending laterally away from the lower portion 139. The denesting tabs 143, as best shown in FIG. 2, can include an upper oblique edge 144 extending from the fold line 185 that extends to an upper lateral edge 146. The lateral edge 146 can intersect an oblique free edge 148 that extends to a lower lateral edge 150 that intersects a respective fold line 153, 157. It will be understood that the denesting tabs 143 can have an alternative configuration without departing from the disclosure.

Similarly, the back panel 127 can include a lower portion 145 foldably connected to the bottom panel 121 at the lateral fold line 129, and an upper portion 147 extending from the lower portion 145. The upper portion 145 of the back panel 127, as shown, can protrude beyond respective endpoints of a respective pair of fold lines 161, 165 associated with the back panel 127 along the lateral axis L2, as described further below, so as to intersect such fold lines 161, 165.

The upper portion 147 of the back panel 127 can thus at least partially define a pair of denesting tabs 149 (broadly, “first denesting tab” and “second denesting tab” or “third denesting tab” and “fourth denesting tab”) extending laterally away from the lower portion 145 thereof. The denesting tabs 149, as shown best in FIG. 1B, can include an upper oblique edge 152 extending from the fold line 189 that extends to an upper lateral edge 154. The lateral edge 154 can intersect an oblique free edge 156 that extends to a lower lateral edge 158 that intersects a respective fold line 161, 165. It will be understood that the denesting tabs 149 can have an alternative configuration without departing from the disclosure.

As described further herein, the tray 105 formed from the blank 103 can be provided with a configuration suitable for nesting with vertically adjacent trays 105, for example, to optimize space savings during transport and/or storage. In such nested arrangements, the denesting tabs 143, 149 can provide a suitable clearance between the panels of a tray 105 and another tray 105 at least partially nested therein, e.g., to minimize, inhibit, and/or prevent substantial face-to-face contact between the trays 105 that would tend to interfere with efficient and low-resistance separation thereof.

With continued reference to FIGS. 1, 1A, and 1B, the plurality of panels of the blank 103 can also include a plurality of end flaps foldably connected to respective panels of the plurality of panels of the blank 103. In the illustrated embodiment, the end flaps can include a side end flap 151 (broadly, “first side end flap” or “second side end flap” or “third side end flap” or “fourth side end flap”) foldably connected to the front panel 123 at an oblique fold line 153 (broadly, “first fold line” or “second fold line” or “third fold line” or “fourth fold line”) and a side end flap 155 (broadly, “first side end flap” or “second side end flap” or “third side end flap” or “fourth side end flap”) foldably connected to the front panel 123 at an oblique fold line 157 (broadly, “first fold line” or “second fold line” or “third fold line” or “fourth fold line”). Similarly, a side end flap 159 (broadly, “first side end flap” or “second side end flap” or “third side end flap” or “fourth side end flap”) can be foldably connected to the back panel 127 at an oblique fold line 161 (broadly, “first fold line” or “second fold line” or “third fold line” or “fourth fold line”), and a side end flap 163 (broadly, “first side end flap” or “second side end flap” or “third side end flap” or “fourth side end flap”) can be foldably connected to the back panel 127 at an oblique fold line 165 (broadly, “first fold line” or “second fold line” or “third fold line” or “fourth fold line”).

In the illustrated embodiment, the side end flaps 151, 159 can be separable from the end panel 131 at respective oblique cuts 160, 166, and the side end flaps 155, 163 can be separable from the end panel 135 at respective oblique cuts 164, 168.

The side end flaps 151, 155, as shown, can have respective lower lateral edges 170 that extend from the respective fold line 153, 157 to respective oblique edges 172. A respective lateral edge 174 can extend from the respective edges 172 to an oblique edge 176 that intersects a respective fold line 175, 177. In this regard, the edges 170, 172 can be positioned at least partially abutting the respective edges 150, 148 of the respective denesting tabs 143.

Similarly, the side end flaps 159, 163 can have respective lower lateral edges 178 that extend from the respective fold lines 161, 165 to respective oblique edges 180. A respective lateral edge 182 can extend from the respective edges 180 to an oblique edge 184 that intersects a respective fold lines 179, 181. In this regard, the edges 178, 180 can be positioned at least partially abutting the respective edges 158, 156 of the respective denesting tabs 149.

Respective reinforcement tabs 167, 169, 171, 173 can be foldably connected to the respective side end flaps 151, 155, 159, 163 at respective oblique fold lines 175, 177, 179, 181. As described further herein, the reinforcement tabs 167, 169, 171, 173 can be positioned to engage one or more of the engagement features of the tray 105 formed from the blank 103, such that at least the reinforcement tabs 167, 169, 171, 173 and associated features can be considered reinforcement features of the blank 103/tray 105.

With continued reference to FIGS. 1, 1A, and 1B, the end flaps can further include a front top end flap 183 foldably connected to the front panel 123 at a lateral fold line 185, and, similarly, a back top end flap 187 can be foldably connected to the back panel 127 at a lateral fold line 189.

The front top end flap 183 can include a central portion 191 and a pair of end portions 193 extending from opposite end portions of the central portion 191. As shown, the end portions 193 can extend at least partially along the longitudinal axis L1 away from the central portion 191 so as to intersect and at least partially extend past the fold line 185.

In some embodiments, the end portions 193 can include a lateral free edge 195 that intersects an oblique or chamfered free edge 197 that intersects a longitudinal free edge 199. The longitudinal free edge 199 can intersect a lateral free edge 201 that extends to an oblique edge 203 that intersects the fold line 185. In this regard, the edges 201, 203 can be positioned at least partially abutting the respective edges 146, 144 of the respective denesting tabs 143. It will be understood that the end portions 193 can be formed by a subcombination of the aforementioned edges and/or can be formed by a different arrangement of edges without departing from the disclosure.

Similarly, the back top end flap 187 can include a central portion 205 and a pair of end portions 207 extending from opposite end portions of the central portion 205. As shown, the end portions 207 can extend at least partially along the longitudinal axis L1 away from the central portion 205 so as to intersect and at least partially extend past the fold line 189.

In some embodiments, the end portions 207 can include a lateral free edge 209 that intersects an oblique or chamfered free edge 211 that intersects a longitudinal free edge 213. The longitudinal free edge 213 can intersect a lateral free edge 215 that extends to an oblique edge 217 that intersects the fold line 189. In this regard, the edges 215, 217 can be positioned at least partially abutting the respective edges 154, 152 of the respective denesting tabs 149. It will be understood that the end portions 207 can be formed by a subcombination of the aforementioned edges and/or can be formed by a different arrangement of edges without departing from the disclosure.

In the illustrated embodiment, a front reinforcement flap 219 can be foldably connected to a portion of the front top end flap 183 at a lateral fold line 221, and a back reinforcement flap 223 can be foldably connected to a portion of the back top end flap 187 at a lateral fold line 225. While the reinforcement flaps 219, 223 are illustrated as having a generally rectangular arrangement foldably connected to a respective central portion 191, 205 of the respective top end flaps 183, 187, it will be understood that one or both of the reinforcement flaps 219, 223 can have a different configuration and/or arrangement without departing from the disclosure. As described further herein, the arrangement of the front reinforcement flap 219 and the back reinforcement flap 223 relative to the respective top end flaps 183, 187 is such to provide additional stiffness/rigidity to one or more portions of the tray 105. In this regard, the front reinforcement flap 219 and the back reinforcement flap 221 can additionally or alternatively be considered reinforcement features of the blank 103/tray 105.

Still referring to FIG. 1, a first end top end flap 227 can be foldably connected to the first end panel 131 at a longitudinal fold line 229, and a second side top end flap 231 can be foldably connected to the second end panel 135 at a longitudinal fold line 233.

In some embodiments, the top end flap 227 can include free edges that includes a longitudinal free edge 235 that intersects at respective endpoints thereof respective chamfered or oblique free edges 237, 239. The respective free edges 237, 239 can intersect respective lateral free edges 241, 243 that intersect respective longitudinal free edges 245, 247 that extend to endpoints of the respective fold line 229. In some embodiments, the top end flap 227 can include a central portion and end portion at least partially defined by the free edges 237, 241, 245 and the free edges 239, 243, 247.

Similarly, in some embodiments, the top end flap 231 can include free edges that includes a longitudinal free edge 249 that intersects at respective endpoints thereof respective chamfered or oblique free edges 251, 253. The respective free edges 251, 253 can intersect respective lateral free edges 255, 257 that intersect respective longitudinal free edges 259, 261 that extend to endpoints of the respective fold line 233. In some embodiments, the top end flap 231 can include a central portion and end portion at least partially defined by the free edges 251, 255, 259 and the free edges 253, 257, 261.

The blank 103 and tray 105 formed therefrom can also include generally a plurality of elongate ovular, e.g., pill-shaped, openings 263 that can be at least partially defined in the bottom panel 121 extending into the respective panels 123, 131, 127, 135 so as to at least partially interrupt the respective fold lines 125, 133, 129, 137. In some embodiments, one or more of the openings 263 can be product visibility features for facilitating inspection into the interior 107 of the tray 105 formed from the blank 103, for example, so that one or more articles such as food products in the interior 107 of the tray 105 can be viewed from the exterior thereof. In some embodiments, one or more of the openings 263 can be points of ingress into or egress from the interior 107 of the tray 105, for example, to provide ventilation, a path for fluid runoff due to incidental leakage, condensation, etc.

While the blank 103 and tray 105 formed therefrom are illustrated as including a plurality of laterally and longitudinally spaced and oriented openings 263, respectively, it will be understood that one or more of the openings 263 can have a different shape and/or configuration without departing from the disclosure.

As shown, spacing/separating/denesting features of the blank 103/tray 105 can include one or more of the denesting tabs 143, 149 (broadly, “first denesting tab”, “second denesting tab”, “third denesting tab” or “fourth denesting tab”, respectively) extending from the respective panels 123, 127. It will be understood that one or more of the denesting tabs 143, 149 can have a different arrangement and/or configuration without departing from the disclosure.

Referring to FIGS. 2 and 2A, according to one embodiment of the disclosure, formation of the tray 105 from the blank 103 can be performed by inverting the blank 103 such that the exterior surface 101 is positioned on a supporting surface and such that the interior surface of the blank 103 can be positioned facing upwardly.

The front panel 123, the back panel 127, the first end panel 131, and the second end panel 135 can be folded upwardly relative to the bottom panel 121 at the respective fold lines 125, 129, 133, 137.

The side end flap 151 can be folded at the fold line 153 into at least partial face-to-face contact with the exterior surface of the first end panel 131 and the side end flap 155 can be folded at the fold line 157 into at least partial face-to-face contact with the exterior surface of the second end panel 135.

Similarly, the side end flap 159 can be folded at the fold line 161 into at least partial face-to-face contact with the exterior surface of the first end panel 131 and the side end flap 163 can be folded at the fold line 165 into at least partial face-to-face contact with the exterior surface of the second end panel 135.

The front top end flap 183 can be folded downwardly at the fold line 185 to extend outwardly from the front panel 123, e.g., in a generally horizontal orientation parallel to the bottom panel 121. Similarly, the back top end flap 187 can be folded downwardly at the fold line 189 to extend outwardly from the back panel 127, the first end panel top end flap 227 can be folded downwardly at the fold line 229 to extend outwardly from the first end panel 131, and the second end panel top end flap 231 can be folded downwardly at the fold line 233 to extend outwardly from the second end panel 135.

In such an arrangement the top end flaps 183, 187 can be positioned overlapping, e.g., in at least partial face-to-face contact with, respective portions of the top end flaps 227, 231 to cooperate and form an upper rim/flange 109 of the tray 105. In some embodiments, the outer portions 193, 207 of the respective top end flaps 183, 187 can overlap respective longitudinally outer marginal portions of the top end flaps 227, 231. In some embodiments, the complementary configuration of the chamfered or oblique edges 197, 211 of the top end flaps 183, 187 can generally align with the respective chamfered oblique edges 237, 239, 251, 253 of the respective top end flaps 227, 231, for example, so as to provide a streamlined edge profile and/or to optimize an available surface area for the application of on adhesive such as glue.

As shown, the aforementioned downward folding of the top end flap 227 at the fold line 229 can cause the reinforcement tabs 167, 171 to fold downwardly at the respective fold lines 175, 179 and the downward folding of the top end flap 231 at the fold line 233 can cause the reinforcement tabs 169, 173 to fold downwardly at the respective fold lines 177, 181. In such an arrangement, the reinforcement tabs 167, 171 can be positioned in at least partial face-to-face contact with the top end flap 227 and the reinforcement tabs 169, 173 can be positioned in at least partial face-to-face contact with the top end flap 231.

The positioning of the reinforcement tabs 167, 171 engaging the top end flap 227 and the positioning of the reinforcement tabs 169, 173 engaging the top end flap 231 is such that the reinforcement tabs 167, 171, 169, 173 can reinforce, e.g., brace, support, bolster, provide pressure points/backpressure, and/or otherwise maintain the configuration of the rim/flange 109 of the tray 105, for example, by minimizing, inhibiting, preventing, and/or otherwise resisting downward movement/deflection and/or deformation of the respective top end flaps 227, 231.

Simultaneously or thereafter, the front reinforcement flap 219 can be folded at the fold line 221 into at least partial face-to-face contact with the top end flap 183, and the back reinforcement flap 223 can be folded at the fold line 225 into at least partial face-to-face contact with the top end flap 187. The aforementioned arrangement of the reinforcement flaps 219, 223 overlying the respective top end flaps 183, 187 is such that a reinforced arrangement of the rim/flange 109 is provided by the two-ply layering of reinforcement flaps 219, 223 atop the respective top end flaps 183, 187.

In this regard, the arrangement of the reinforcement flaps 219, 223 overlying the respective top end flaps 183, 187 provides the rim/flange 109 with an increased capacity to minimize, inhibit, avoid, prevent, and/or otherwise resist bending, bowing, flexing, buckling, curling, deflection, and/or other deformation of the rim/flange 109.

The aforementioned arrangement of the tray 105 can be maintained with an adhesive such as glue. Such adhesion of the reinforcement tabs 167, 169, 171, 173 to the rim/flange 109 of the tray 105 can further reinforce the rim/flange 109 and tray 105. In one embodiment, the reinforcement flap 219 can be adhered to the top end flap 183, and the reinforcement flap 223 can be adhered to the top end flap 187.

It will be further understood that portions of the blank 103 described herein, e.g., top end flaps, side end flaps, denesting tabs, etc., can be at least partially separable from one another at cuts that are complementary, e.g., so as to at least partially define, free edge portions thereof as described above in the course of forming the tray 105.

In the illustrated embodiment of the tray 105, the panels 123, 127, 131, 135 can extend generally upwardly and obliquely outwardly from the bottom panel 121 such that the tray 105 has a generally tapered configuration, e.g., such that a top opening defined by the upper edges of the panels 123, 127, 131, 135 is larger than the bottom panel 121.

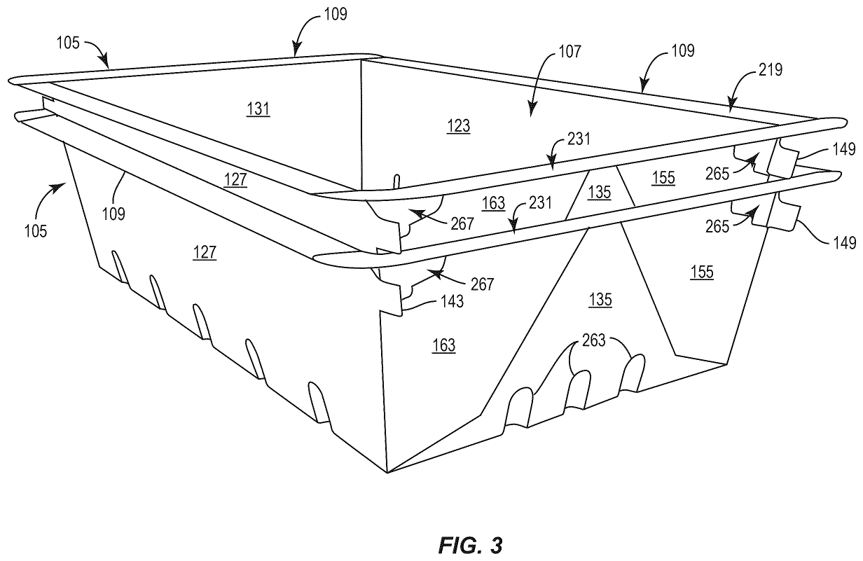

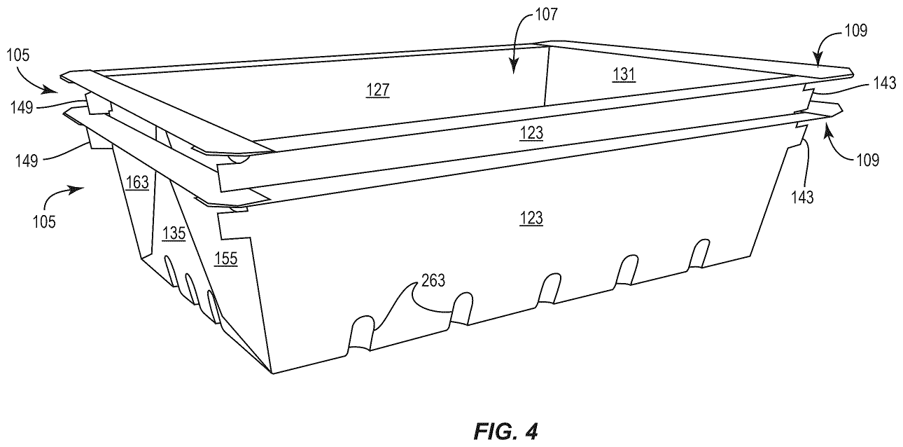

In this regard, and with additional reference to FIGS. 3 and 4, the tray 105 can be provided with a configuration suitable for nesting with vertically adjacent trays 105, for example, to optimize space savings during transport and/or storage. In such nested arrangements, the denesting tabs 143, 149 extending away from the respective side panels 123, 127 and away from the respective end panels 131, 135 can provide a suitable clearance between the panels of a tray 105 and another tray 105 at least partially nested therein, e.g., to minimize, inhibit, and/or prevent substantial face-to-face contact between the trays 105 that would tend to interfere with efficient and low-resistance separation thereof.

A shown, a lower or receiving tray 105 can be positioned to at least partially receive an upper or nested tray 105 therein. In this regard, the upper tray 105 can be lowered into the interior 107 of the lower tray 105, and the positioning of the denesting tabs 143, 149 is such to provide a stop/spacing between the bottom panel 121 of the upper tray 105 and the bottom panel 121 of the lower tray 105 to minimize, inhibit, resist, avoid and/or prevent unwanted coupling/connection between the trays 105 that would tend to resist the efficient and low-resistance separation thereof.

In some embodiments, the respective lower edges 150 of the denesting tabs 143 of the upper tray 105 can be positioned contacting the rim/flange 109 of the lower tray 105. In some embodiments one or both of the upper edges 144, 146 thereof can be positioned to contact the underside of the rim/flange 109 of the upper tray 105.

Similarly, the respective lower edges 158 of the denesting tabs 149 of the upper tray 105 can be positioned contacting the rim/flange 109 of the lower tray 105. In some embodiments, one or both of the upper edges 152, 154 thereof can be positioned to contact the underside of the rim/flange 109 of the upper tray 105.

It will be understood that one or more food products P can be dropped, placed, or otherwise positioned in the interior 107 of the tray 105 during or subsequent to the aforementioned steps. In one embodiment, the food products can be tomatoes, though one or more of the food products can be a different food product without departing from the disclosure. The tray 105 can be provided with one or more food products as a package.

In this regard, the denesting tabs 143, 149 of the upper tray 105 can be positioned extending away from the respective panels 123, 127, 131, 135 thereof, e.g., exteriorly of the tray 105 and away from the interior 107 thereof, so as to avoid interference with any food products P in the interior 107 of the tray(s) 105 and/or the retrieval thereof by a user.

Still referring to FIGS. 2-4, engagement features of the tray 105 include the arrangement of the top end flaps 183, 187, 227, 231 and the reinforcement flaps 219, 223, together or in subcombinations. As shown, the folded arrangement of the top end flaps 183, 187, 227, 231 and the reinforcement flaps 219, 223 extending outwardly from the respective panels forms the rim 109 and one or more engagement surfaces for being engaged/supported by an element associated with a forming apparatus for the tray 105, for example a machine element such as a grasper, fork, pincer, rail, etc. In one embodiment, the exterior (e.g., downward facing) surface of the top end flaps can present engagement surfaces for being engaged/supported by such a machine component. In other embodiments, engagement surfaces can include any combination of one or more of the exterior, interior (e.g., upward facing), and/or side-facing surfaces of one or more of the top end flaps 183, 187, 227, 231 and the reinforcement flaps 219, 223.

As shown in FIG. 2A, the positioning of the top end flaps 183, 187, 227, 231 and the reinforcement flaps 219, 223 extending away from the panels of the tray 105, also presents a plurality of engagement/support surfaces for engaging/supporting a covering or lidding film L, e.g., a plastic or other polymeric film, or other covering structure. In one embodiment, the lidding film can be provided as a polymeric layer that at least partially deforms in the presence of a heat source, e.g., a heat sealable film. The lidding film can thus be positioned extending across a top opening of the tray 105 in contact with one or more surfaces of one or more of the top end flaps 183, 187, 227, 231 and one or more of the reinforcement flaps 219, 223 to cover the interior 107 of the tray 105 and maintain one or more conditions of the food products P held therein, e.g., freshness, ripeness, moisture content, etc. It will be understood that the lidding film can minimize, inhibit, and/or prevent the passage of one or more materials into the interior 107 of the tray 105, for example, condensation or other moisture, insects or other pests, dirt, debris, etc. In one embodiment, the tray 105 can be provided together with the lidding film and one or more food products as a package.

Furthermore, the reinforcement features of the tray 105 can include at least the reinforcement tabs 167, 169, 171, 173, the positioning of which under and at least partially contacting the respective top end flaps 227, 231 can minimize, inhibit, avoid, prevent, and/or otherwise resist bending, bowing, flexing, buckling, curling, deflection, and/or other deformation of the rim/flange 109. The reinforcement features of the tray 105 can additionally include the overlapping arrangement of the reinforcement flaps 219, 223 with the respective top end flaps 183, 187. In this regard, forces exerted on the rim/flange 109 via tension applied through a covering or lidding film disposed thereon can minimize, inhibit, and/or prevent deformation of the rim/flange 109, e.g., to avoid undesirable product aesthetics, to avoid at least partial disengagement of the lidding film with the rim/flange 109, to maintain a generally planar configuration of the rim/flange 109 for stacking, storage, transport, etc. In this regard, the reinforcement flaps 219, 223 can be both engagement features and reinforcement features of the tray 105.

In the illustrated embodiment, the arrangement of the edges 170, 172, 174, 176 of the side end flaps 151, 155 can form respective lugs 265 between such free edges, the flange 109 of the tray 105, and the respective end panel 131, 135. Similarly, the arrangement of the edges 178, 180, 182, 184 of the side end flaps 159, 163 can form respective lugs 267 between such free edges, the flange 109 of the tray 105, and the respective end panel 131, 135. In some embodiments, the respective lugs 265, 267 can provide access features at least partially defined by the respective edges 170, 172, 174, 176, 178, 180, 182, 184 that can at least partially receive a respective machine component, e.g., a fork, pincer, finger, other element, etc., for manipulating one or more trays 105. For example, in some embodiments, 265, 267 can facilitate the engagement and/or separation of nested trays 105.

It will be understood that one or more of the panels, flaps, and associated features of the blank 103/tray 105 can have a different arrangement or configuration without departing from the disclosure.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blanks. In accordance with the above-described embodiments, the blank may be constructed of paperboard of a caliper such that it is heavier and more rigid than ordinary paper. The blanks can also be constructed of other materials, such as cardboard, hard paper, or any other material having properties suitable for enabling the trays, to function at least generally as described above. The blanks can also be laminated to or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the spaced apart slits to be replaced with a continuous slit, a continuous score, or the like. For example, a cut line can be a continuous slit or could be wider than a slit without departing from the present disclosure. Also, a tear line can be a series of cut scores passing completely, or partially, through the material, that are separated by nicks.

The term “glue” is intended to encompass all manner of adhesives commonly used to secure tray panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A tray for holding at least one food product, the tray comprising:
a plurality of panels extending at least partially around an interior of the tray, the plurality of panels comprising a bottom panel, a front panel, a back panel, and at least one end panel;
a plurality of end flaps foldably connected to a respective panel of the plurality of panels and cooperating to form a rim extending outwardly from the plurality of panels; and
denesting features comprising at least one denesting tab extending from one of the front panel and the back panel and away from the at least one end panel.

2. The tray of claim 1, wherein the one of the front panel and the back panel comprises a lower portion and an upper portion, the at least one denesting tab at least partially defined along the upper portion and extending away from the lower portion.

3. The tray of claim 1, wherein the plurality of end flaps further comprises a plurality of end flaps comprising a plurality of top end flaps cooperating to form the rim and a plurality of side end flaps, at least one side end flap foldably connected to the one of the front panel and the back panel at a fold line, the at least one denesting tab extending past the fold line.

4. The tray of claim 3, wherein the at least one denesting tab defines a lower free edge, the lower free edge intersecting the fold line.

5. The tray of claim 4, wherein the at least one side end flap is positioned in at least partial face-to-face contact with the at least one end panel.

6. The tray of claim 2, wherein the at least one denesting tab is a first denesting tab extending from the one of the front panel and the back panel, and the denesting features further comprise a second denesting tab at least partially defined along the upper portion and extending away from the lower portion of the one of the front panel and the back panel.

7. The tray of claim 6, wherein the one of the front panel and the back panel is the front panel, the back panel comprises a lower portion and an upper portion, and the denesting features further comprise a third denesting tab at least partially defined along the upper portion of the back panel and extending away from the lower portion of the back panel.

8. The tray of claim 1, wherein the at least one side end flap is a first side end flap foldably connected to the front panel at the fold line, the fold line is a first fold line, and the plurality of side end flaps further comprises a second side end flap foldably connected to the back panel at a second fold line, the third denesting tab extending past the second fold line.

9. The tray of claim 3, wherein the plurality of end flaps comprises a front top end flap foldably connected to the front panel, a back top end flap foldably connected to the back panel, and a side top end flap foldably connected to the at least one side panel, the side top end flap overlaps respective portions of the front top end flap and the back top end flap.

10. The tray of claim 9, further comprising a front reinforcement flap foldably connected to the front top end flap and at least partially overlapping the front top end flap for reinforcing the rim, the tray further comprising a back reinforcement flap foldably connected to the back top end flap and at least partially overlapping the back top end flap for reinforcing the rim.

11. A blank for forming a tray for holding at least one food product, the blank comprising:
a plurality of panels for extending at least partially around an interior of the tray formed from the blank, the plurality of panels comprising a bottom panel, a front panel, a back panel, and at least one end panel;
a plurality of end flaps foldably connected to a respective panel of the plurality of panels and for cooperating to form a rim extending outwardly from the plurality of panels when the tray is formed from the blank; and
denesting features comprising at least one denesting tab extending from one of the front panel and the back panel and for extending away from the at least one end panel when the tray is formed from the blank.

12. The blank of claim 11, wherein the one of the front panel and the back panel comprises a lower portion and an upper portion, the at least one denesting tab at least partially defined along the upper portion and extending away from the lower portion.

13. The blank of claim 11, wherein the plurality of end flaps further comprises a plurality of end flaps comprising a plurality of top end flaps for cooperating to form the rim when the tray is formed from the blank, and a plurality of side end flaps, at least one side end flap foldably connected to the one of the front panel and the back panel at a fold line, the at least one denesting tab extending past the fold line.

14. The blank of claim 13, wherein the at least one denesting tab defines a lower free edge, the lower free edge intersecting the fold line.

15. The blank of claim 12, wherein the at least one denesting tab is a first denesting tab extending from the one of the front panel and the back panel, and the denesting features further comprise a second denesting tab at least partially defined along the upper portion and extending away from the lower portion of the one of the front panel and the back panel.

16. The blank of claim 15, wherein the one of the front panel and the back panel is the front panel, the back panel comprises a lower portion and an upper portion, and the denesting features further comprise a third denesting tab at least partially defined along the upper portion of the back panel and extending away from the lower portion of the back panel.

17. The blank of claim 11, wherein the at least one side end flap is a first side end flap foldably connected to the front panel at the fold line, the fold line is a first fold line, and the plurality of side end flaps further comprises a second side end flap foldably connected to the back panel at a second fold line, the third denesting tab extending past the second fold line.

18. The blank of claim 12, further comprising a front reinforcement flap foldably connected to the front top end flap and for at least partially overlapping the front top end flap for reinforcing the rim when the tray is formed from the blank, the blank further comprising a back reinforcement flap foldably connected to the back top end flap and for at least partially overlapping the back top end flap for reinforcing the rim when the tray is formed from the blank.

19. A method of forming a tray for holding at least one food product, the method comprising:
obtaining a blank, the blank comprising a plurality of panels comprising a bottom panel, a front panel, a back panel, and at least one end panel, a plurality of end flaps foldably connected to a respective panel of the plurality of panels, and denesting features comprising at least one denesting tab extending from one of the front panel and the back panel;
positioning the plurality of panels extending at least partially around an interior of the tray;
positioning the plurality of end flaps cooperating to form a rim extending outwardly from the plurality of panels; and
positioning the at least one denesting tab extending away from the at least one end panel.

20. The method of claim 19, wherein the one of the front panel and the back panel comprises a lower portion and an upper portion, the at least one denesting tab at least partially defined along the upper portion and extending away from the lower portion.

21. The method of claim 19, wherein the plurality of end flaps further comprises a plurality of end flaps comprising a plurality of top end flaps and a plurality of side end flaps, at least one side end flap foldably connected to the one of the front panel and the back panel at a fold line, the at least one denesting tab extending past the fold line, and positioning the plurality of end flaps cooperating to form the rim comprises positioning the plurality of top end flaps cooperating to form the rim.

22. The method of claim 21, wherein the at least one denesting tab defines a lower free edge, the lower free edge intersecting the fold line.

23. The method of claim 22, comprising positioning the at least one side end flap in at least partial face-to-face contact with the at least one end panel.

24. The method of claim 20, wherein the at least one denesting tab is a first denesting tab extending from the one of the front panel and the back panel, and the denesting features further comprise a second denesting tab at least partially defined along the upper portion and extending away from the lower portion of the one of the front panel and the back panel.

25. The method of claim 24, wherein the one of the front panel and the back panel is the front panel, the back panel comprises a lower portion and an upper portion, and the denesting features further comprise a third denesting tab at least partially defined along the upper portion of the back panel and extending away from the lower portion of the back panel.

26. The method of claim 19, wherein the at least one side end flap is a first side end flap foldably connected to the front panel at the fold line, the fold line is a first fold line, and the plurality of side end flaps further comprises a second side end flap foldably connected to the back panel at a second fold line, the third denesting tab extending past the second fold line.

27. The method of claim 20, wherein the plurality of end flaps comprises a front top end flap foldably connected to the front panel, a back top end flap foldably connected to the back panel, and a side top end flap foldably connected to the at least one side panel, the method comprises positioning the side top end flap overlapping respective portions of the front top end flap and the back top end flap.

28. The method of claim 27, wherein the blank further comprises a front reinforcement flap foldably connected to the front top end flap a back reinforcement flap foldably connected to the back top end flap, and the method further comprises and at least partially overlapping the front reinforcement flap on the front top end flap for reinforcing the rim and at least partially overlapping the back reinforcement flap on the back top end flap for reinforcing the rim.
